(19) United States
(12) Patent Application Publication
(10) Pub. No.: US 2011/0234731 A1
(43) Pub. Date: Sep. 29, 2011

(54) RECORDING DEVICE

(75) Inventors: Takamitsu Fujimaki, Matsumoto-shi (JP); Hiroyuki Nakayama, Shiojiri-shi (JP)

(73) Assignee: Seiko Epson Corporation, Tokyo (JP)

(21) Appl. No.: 13/072,070

(22) Filed: Mar. 25, 2011

(30) Foreign Application Priority Data
Mar. 25, 2010 (JP) 2010-069999
Feb. 8, 2011 (JP) 2011-024836

(51) Int. Cl. B41J 2/01

(52) U.S. Cl. 347/104

(57) ABSTRACT

Paper jams and paper cutting problems are prevented by limiting sideways movement of the recording medium because wrinkles and sags in the recording medium produced by pulling sideways on the recording medium are caught by a notch unit. A recording device that pulls and records on a recording medium that is wound in a roll has a discharge guide unit that forms a discharge path for the recorded recording medium. The discharge guide unit has a discharge guide surface facing a surface of the recording medium, and has a notch unit disposed to the discharge-side end of the discharge guide surface.

### BACKGROUND

Priority is claimed under 35 U.S.C. § 119 from Japanese patent application nos. JP 2010-069999 filed on Mar. 25, 2010 and JP 2011-024836 filed on Feb. 8, 2011, which are hereby incorporated by reference in their entirety.

1. Technical Field

The present invention relates to a recording device and relates more particularly to a recording device that pulls and records on a recording medium that is wound into a roll.

2. Related Art

Receipt printers that pull and print on recording paper that is wound onto a roll are used in POS (point-of-sale) systems. For example. Japanese Unexamined Patent Appl. Pub. JP-A-2007-83478 teaches a printer that uses a plurality of rollers to pull recording paper loaded into a roll paper compartment through the printer, and prints on the recording paper using an inkjet head. When the printing operation ends and the recording paper is discharged from the paper exit, this printer temporarily stops conveying the recording paper while the discharged portion of the paper is cut by a cutting device into a receipt of a particular length.

However, if the user pulls the recording paper to the side or up in order to tear the paper off while the paper is being discharged, the paper may be wrinkled or sag as a result of the recording paper being pushed against the side of the paper exit. This wrinkling or sagging of the recording paper may result in a paper jam in the paper discharge path leading to the paper exit, and result in the paper not being properly cut by the paper cutter.

### SUMMARY

A recording device according to at least one embodiment of the present invention enables a smooth discharge of the recording medium while making it difficult for paper jams and paper cutting problems to occur.

A recording device according to a first aspect of at least one embodiment of the invention that pulls and records on a recording medium that is wound into a roll has a discharge guide unit that forms a discharge path for the recorded recording medium. The discharge guide unit has a discharge guide surface facing a surface of the recording medium, and has a notch unit disposed to the discharge-side end of the discharge guide surface.

This aspect of the invention limits sideways movement of the recording medium because wrinkles and sags in the recording medium produced by pulling sideways on the recording medium are caught by the notch unit. As a result, paper jams and paper cutting problems are prevented.

In a recording device according to another aspect of at least one embodiment of the invention, the notch unit is preferably a groove in the discharge guide surface extending from the discharge-side end along the discharge path.

In a recording device according to another aspect of at least one embodiment of the invention, the discharge-side end preferably has a recess formed on both sides in the direction perpendicular to the direction of the discharge path.

These aspects of the invention limit the sideways movement of the recording medium when the recording medium is pulled and twisted because the edge of the recording medium is caught by the recess. As a result, paper jams and paper cutting problems are prevented.

In a recording device according to another aspect of at least one embodiment of the invention, the width of the discharge guide surface is less than the width of the recording medium.

This aspect of the invention limits the sideways movement of the recording medium when the recording medium is pulled and twisted because the edge of the recording medium is caught by the recess. As a result, paper jams and paper cutting problems are prevented.

In a recording device according to another aspect of at least one embodiment of the invention, a plurality of notch units are disposed on the discharge-side end in the direction perpendicular to the direction of the discharge path.

This aspect of the invention makes it difficult for the recording medium to shift sideways when the recording medium is pulled sideways because wrinkles and sags in the recording medium are caught by the notches. As a result, paper jams and paper cutting problems are prevented.

In a recording device according to another aspect of at least one embodiment of the invention, the discharge guide surface is preferably connected at the discharge-side end to a support unit that supports the discharge guide surface from the paper exit side from which the recording medium is discharged.

In a recording device according to another aspect of at least one embodiment of the invention, the discharge guide unit is preferably disposed so that the discharge guide surface substantially touches the surface of the discharged recording medium from above.

This aspect of the invention makes it difficult for the recording medium to shift sideways when the recording medium is pulled sideways because wrinkles and sags in the recording medium are caught by the notches. As a result, paper jams and paper cutting problems are prevented.

In a recording device according to another aspect of at least one embodiment of the invention, a discharge roller that discharges the recording medium between a printhead and the discharge guide unit.

In a recording device according to another aspect of at least one embodiment of the invention, a cutter mechanism that cuts the recording medium is positioned between the discharge roller and the discharge guide unit.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is an external oblique view of an inkjet printer according to a preferred embodiment of a recording device according to the invention.

FIG. 2 is a side section view of the inkjet printer 1.

FIG. 3 is an oblique view of the inkjet printer 1 when the roll paper cover 3 is open.

FIG. 4 is an enlarged view of the area around the paper exit 9 shown in FIG. 2.

FIG. 5 is an oblique view of the top discharge guide 50.

FIG. 6A is a front view of the top discharge guide 50.

FIG. 6B is a close-up view of the portion of FIG. 6A in the vicinity of the lines A-A and B-B.

FIG. 6C is a top view of the top discharge guide 50.

FIG. 7A is a section view of the top discharge guide 50 through line A-A in FIG. 6A.

FIG. 7B is a section view of another top discharge guide 50 through line A-A in FIG. 6A.

FIG. 8A is a section view of the top discharge guide 50 through line B-B in FIG. 6A.

FIG. 8B is a section view of another top discharge guide 50 through line B-B in FIG. 6A.

FIG. 9 illustrates what happens when the roll paper 11 discharged from the paper exit 9 is pulled sideways by hand.

FIG. 10 illustrates what happens when the roll paper 11 discharged from the paper exit 9 is pulled diagonally upward by hand.

### DESCRIPTION OF EMBODIMENTS

An inkjet printer 1 according to a preferred embodiment of a recording device according to the invention is described below with reference to the accompanying figures.

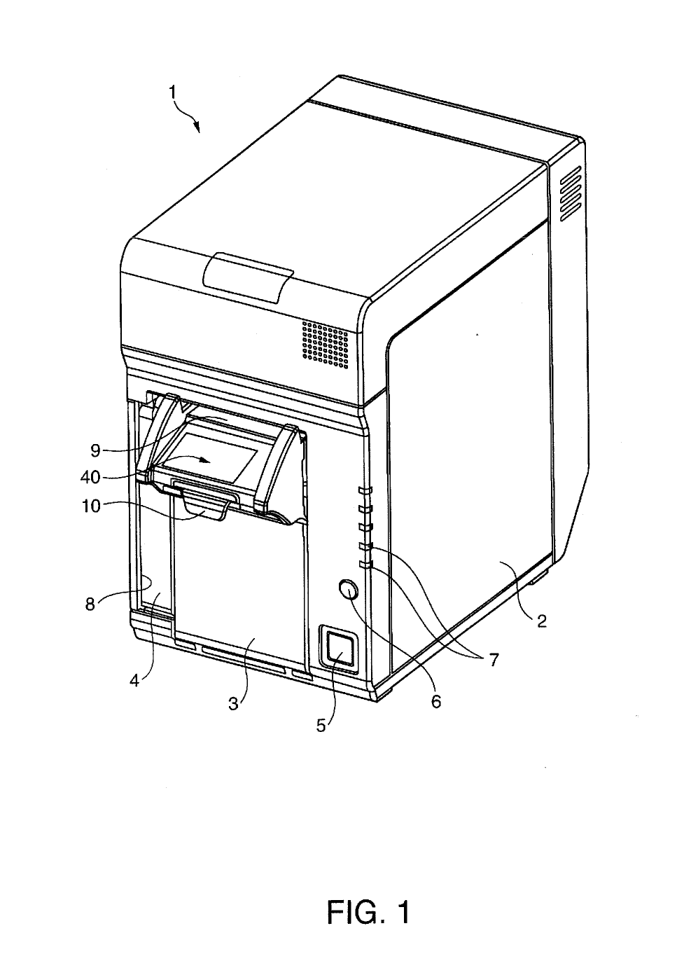

FIG. 1 is an oblique view of the inkjet printer 1. The inkjet printer 1 is a device that can, for example, pull recording paper that is wound into a roll (referred to herein as roll paper) and print in color using plural colors of ink. Note that this roll paper is an example of a recording medium that the inkjet printer 1 can print on.

As shown in FIG. 1, the inkjet printer 1 has a roll paper cover 3 in the front middle part of the printer case 2 that covers the print assembly. A paper exit 9 from which the roll paper 11 is discharged after printing is positioned at the top of the roll paper cover 3 at the front of the print assembly.

An ink cartridge loading opening 8 is disposed beside the roll paper cover 3, and an ink cartridge 4 filled with ink is inserted into the ink cartridge loading opening 8. A power switch 5, feed switch 6, and indicators 7 that display the status of the inkjet printer 1 are disposed at the front of the printer case 2.

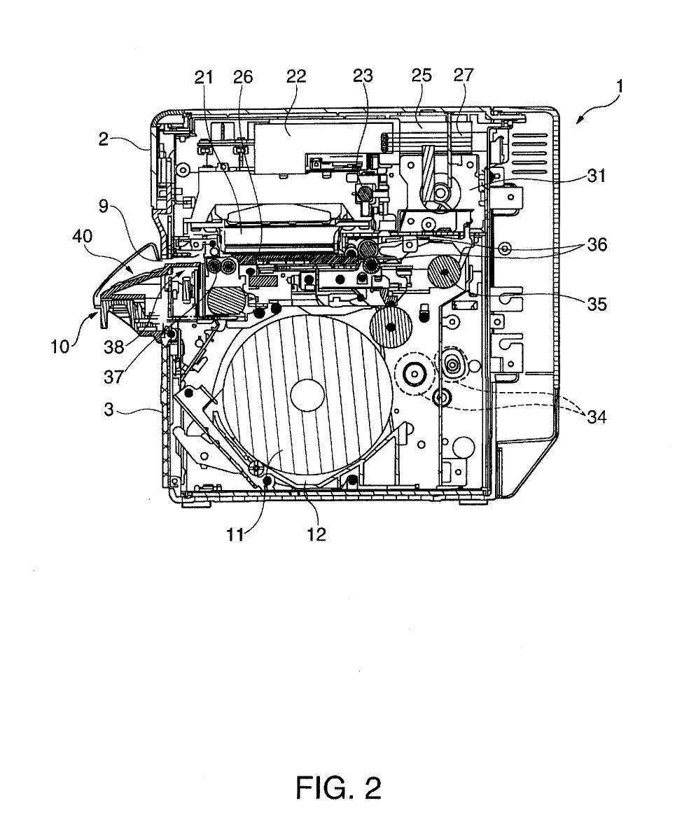

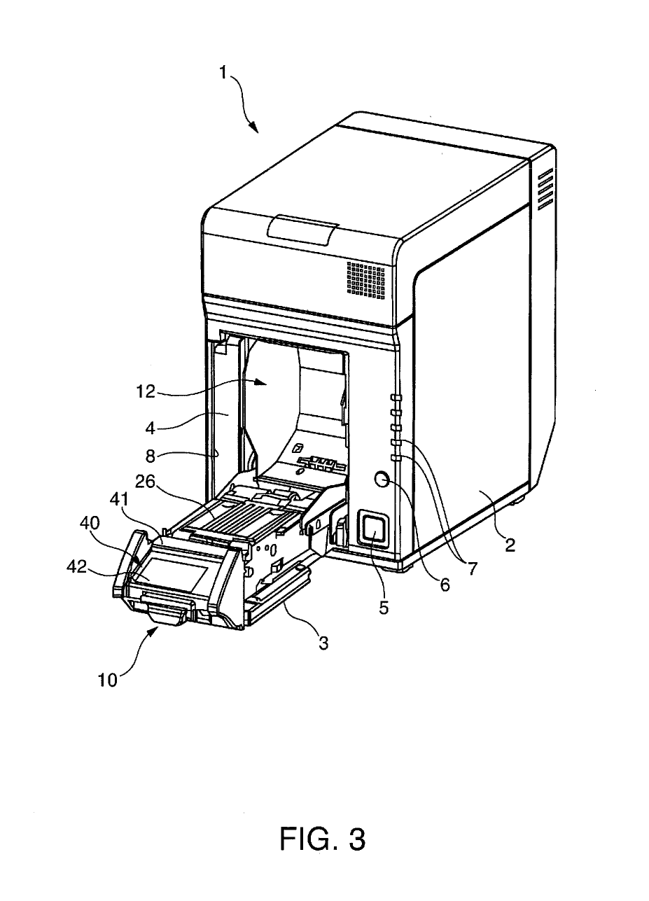

FIG. 2 is a side section view of the inkjet printer 1. FIG. 3 is an oblique view of the inkjet printer 1 when the roll paper cover 3 is open.

As shown in FIG. 2, the roll paper 11 is wound in a roll and stored in a roll paper compartment 12 inside the roll paper cover 3. The roll paper cover 3 can be pulled forward and open while pivoting at the bottom end thereof by pulling forward on a slider 10 disposed near the top of the roll paper cover 3. More specifically, when the slider 10 is manually pulled forward, the slider 10 slides forward and the lock is released.

When the slider 10 is then pulled further forward, the roll paper cover 3 pivots at the bottom end thereof from the position shown in FIG. 1 to the position shown in FIG. 3. When the roll paper cover 3 thus pivots, the roll paper compartment 12 is opened and the roll paper 11 can be dropped in.

As shown in FIG. 2, supply rollers 34 that pull the recording paper in sheet form from the roll paper 11 stored in the roll paper compartment 12 are disposed inside the inkjet printer 1 at the back of the roll paper compartment 12. Main feed rollers 36 that grip and convey the roll paper 11 pulled off the paper roll by the supply rollers 34 are disposed above the supply rollers 34.

The roll paper 11 pulled by the supply rollers 34 travels around a tension roller 35 disposed behind the main feed rollers 36. The tension roller 35 is urged by an urging member (not shown in the figure) towards the back of the printer to hold the tension of the roll paper 11 on the main feed rollers 36 constant. Discharge rollers 37 that grip and convey the roll paper 11 to the paper exit 9 side are disposed in front of the main feed rollers 36.

The roll paper 11 stored in the roll paper compartment 12 is pulled by the supply rollers 34, passes the tension roller 35, main feed rollers 36, and discharge rollers 37, and is discharged from the paper exit 9. The roll paper 11 is conveyed so that the width direction of the paper surface (referred to below as the paper width) is substantially parallel to the width direction of the inkjet printer 1 between the main feed rollers 36 and discharge rollers 37.

Note that in the inkjet printer 1 according to this embodiment of the invention, at least the supply rollers 34, main feed rollers 36, and discharge rollers 37 are rotationally driven by the drive power of drive motors 31 and 39 transmitted thereto by a transmission mechanism (not shown in the figure) including gears or a belt and pulley mechanism, for example.

A platen 26 is disposed widthwise to the inkjet printer 1 above the roll paper compartment 12 between the main feed rollers 36 and discharge rollers 37. A carriage 22 is disposed above the platen 26. The carriage 22 is supported freely movably widthwise to the printer by a guide member 23 that extends widthwise to the inkjet printer 1. The carriage 22 is attached to an endless belt (not shown in the figure) that is disposed substantially parallel to the guide member 23. When the carriage motor 25 drives the endless belt, the carriage 22 moves bidirectionally widthwise to the roll paper 11 conveyed between the main feed rollers 36 and discharge rollers 37.

An inkjet head 21 is disposed on the bottom of the carriage 22. The carriage 22 and ink cartridge 4 are connected by a flexible ink tube 27. The ink stored in the ink cartridge 4 is supplied through this ink tube 27 to the inkjet head 21 on the carriage 22.

The standby position (home position) of the bidirectionally moving carriage 22 is located at one widthwise side of the inkjet printer 1. An ink suction mechanism (not shown in the figure) that suctions ink into the ink nozzles of the inkjet head 21 exposed at the bottom of the carriage 22 is disposed at the bottom of this standby position. The inkjet printer 1 prints by ejecting ink from the inkjet head 21 of the bidirectionally moving carriage 22 onto the portion of the roll paper 11 conveyed passed the inkjet head 21.

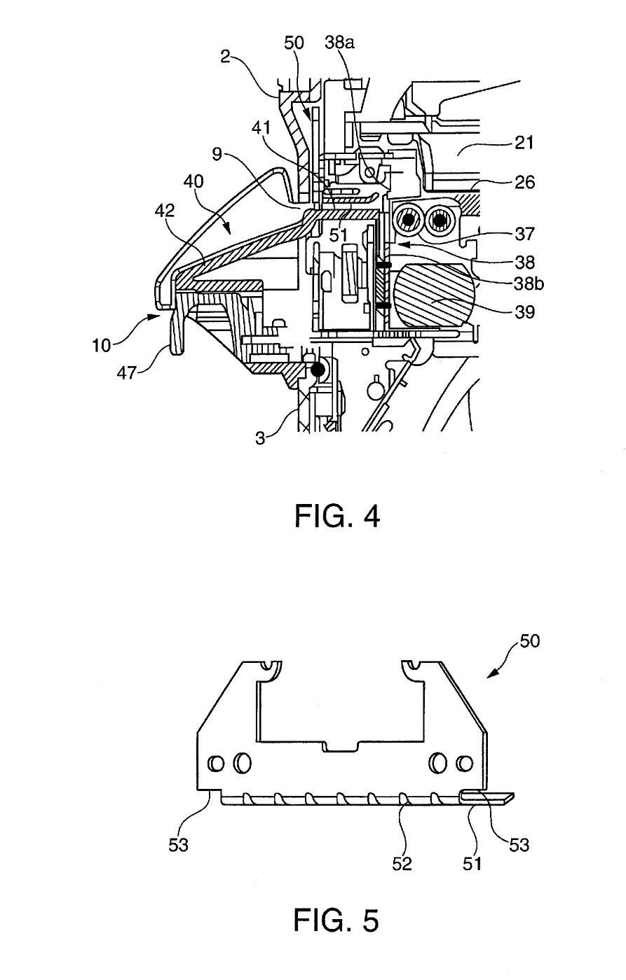

FIG. 4 is an enlarged view of the area proximal to the paper exit 9 in FIG. 2. As shown in FIG. 4, a cutter mechanism 38 is disposed in the roll paper 11 transportation between the discharge rollers 37 and the paper exit 9. The cutter mechanism 38 has a fixed knife 38a disposed on the top side, and a movable knife 38b disposed on the bottom side. The cutter mechanism 38 cuts the roll paper 11 between the fixed knife 38a and movable knife 38b by driving the movable knife 38b vertically by means of drive motor 39.

A bottom discharge guide 40 and a top discharge guide 50 for guiding the roll paper 11 conveyed downstream by the discharge rollers 37 to the paper exit 9 are disposed on the paper exit 9 side of the cutter mechanism 38.

The bottom discharge guide 40 is a hard plastic molding that can be formed in a single piece. The bottom discharge guide 40 includes a bottom discharge guide surface 41 formed in the transportation direction of the roll paper 11 between the discharge rollers 37 and paper exit 9, and an inclined surface 42 that supports the roll paper 11 discharged from the paper exit 9 from below. A grip 47 that the user holds when opening and closing the roll paper cover 3 is disposed on the bottom discharge guide 40 below the inclined surface 42. The user can open the roll paper cover 3 by holding the bottom discharge guide 40 with a finger caught on the grip 47.

The top discharge guide 50 is a flat, basically L-shaped member. The top discharge guide 50 includes a top discharge guide surface 51 disposed in the transportation direction of the roll paper 11 between the discharge rollers 37 and paper exit 9, and a support part 54 that supports the top discharge guide surface 51 from the paper exit 9 side. The top discharge guide surface 51 has a discharge side end 55, which is the end of the top discharge guide surface 51 on the paper exit 9 side. The top discharge guide surface 51 and support part 54 are joined together at this discharge side end 55. The top discharge guide surface 51 is disposed above the bottom discharge guide surface 41 of the bottom discharge guide 40 and opposes the bottom discharge guide surface 41. The roll paper 11 is conveyed from the discharge rollers 37 to the paper exit 9 and is discharged from the paper exit 9 through a discharge path formed by the bottom discharge guide surface 41 of the bottom discharge guide 40 and the top discharge guide surface 51 of the top discharge guide 50.

More specifically in the inkjet printer 1 according to this embodiment of the invention, the top discharge guide 50 is disposed so that the top discharge guide surface 51 contacts the surface of the roll paper 11 on the discharge roller 37 side of the paper exit 9. The top discharge guide 50 and top discharge guide surface 51 are examples of the discharge guide member and discharge guide surface, respectively in the accompanying claims.

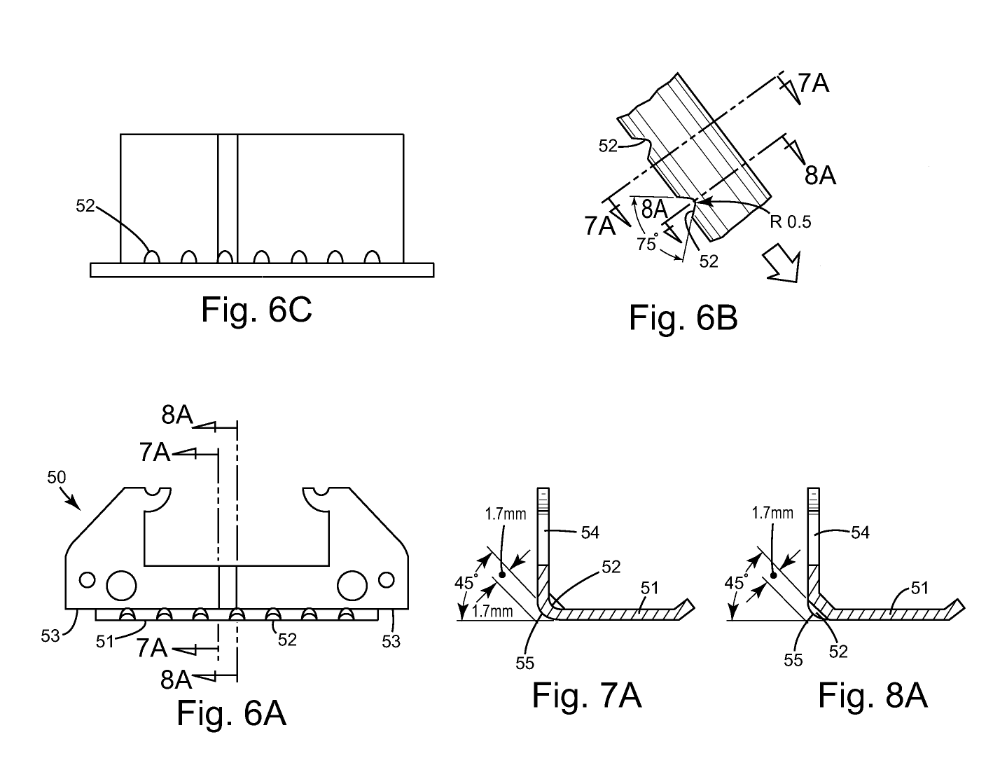

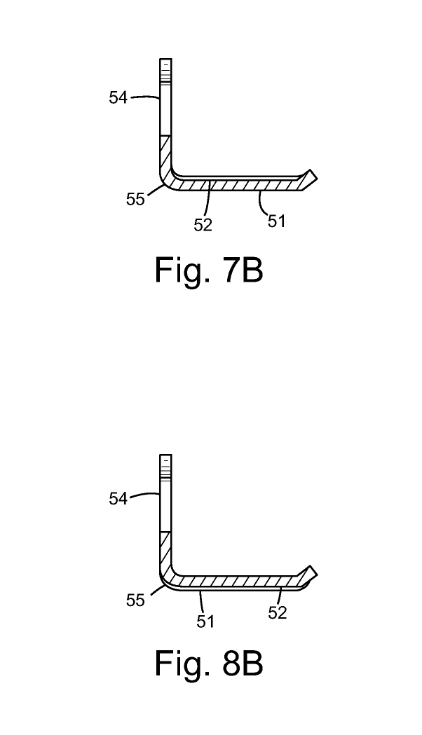

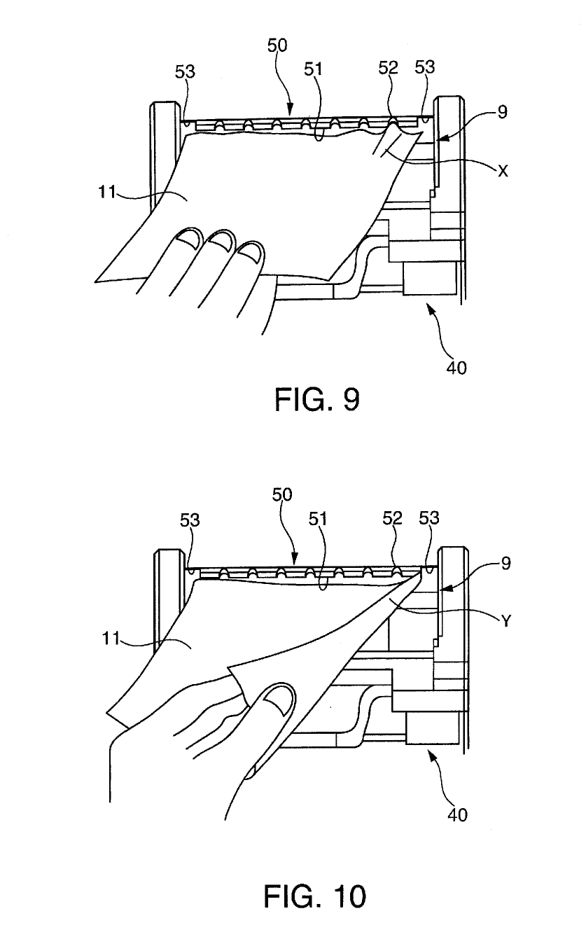

FIG. 5 is an oblique view of the top discharge guide 50. FIG. 6A is a front view of the top discharge guide 50. FIG. 6B is a close-up view of the portion of FIG. 6A in the vicinity of the lines A-A and B-B. FIG. 6C is a top view of the top discharge guide 50. FIG. 7A and FIG. 7B are section views of the top discharge guide 50 through line A-A in FIG. 6A, and FIG. 8A and FIG. 8B are section views of the top discharge guide 50 through line B-B in FIG. 6A. FIG. 9 illustrates what happens when the user pulls the roll paper 11 discharged from the paper exit 9 sideways, and FIG. 10 illustrates what happens when the user pulls the roll paper 11 discharged from the paper exit 9 up at an angle.

As will be understood from FIG. 5 to FIG. 8, a plurality of notches 52 are disposed on the discharge side end 55 of the top discharge guide 50. These plural notches 52 can be formed by a press process, for example, and as shown in FIG. 7A and FIG. 8A are formed so that the thickness of the discharge side end 55 does not become thinner and there are no burrs. As a result, the roll paper 11 can be smoothly conveyed in the discharge direction (the roll paper 11 transportation direction) without reducing the strength of the top discharge guide 50. In addition, as shown in FIG. 7B and FIG. 8B, the plural notches 52 may be formed from the discharge side end 55 in the top discharge guide surface 51 as substantially straight grooves aligned with the direction of the discharge path. As shown in FIG. 6B, the sides of the notches 52, when viewed from the front, can extend at approximately 75 degrees and the end of the notches can have a radius of curvature of approximately 0.5 mm. As shown in FIGS. 7A and 8A, the edge of the notches 52 extends at a 45 degree angle relative to the top discharge guide surface 51, and the depth of the notches 52 extends approximately 1.7 mm from the edge of the discharge side end 55 in a direction approximately 45 degrees relative to the top discharge guide surface 51.

By thus forming these notches 52 in the top discharge guide surface 51, wrinkles (indicated by X in FIG. 9) created in the roll paper 11 when the user pulls the roll paper 11 sideways as shown in FIG. 9 catch on the notches 52, thus limiting movement of the roll paper 11 widthwise. In addition, because there are plural notches 52 formed in the top discharge guide surface 51 as shown in FIG. 5 and FIG. 6A, wrinkles and sags formed in the roll paper 11 can be caught more easily by the notches 52 than if there is only one notch.

In addition, the top discharge guide 50 is disposed in this embodiment of the invention so that the top discharge guide surface 51 is at a position slightly higher than the elevation of the surface of the roll paper 11 conveyed from the discharge rollers 37, and the roll paper 11 grazes the surface of the top discharge guide surface 51. As an example, the top discharge guide surface can be positioned approximately 1 mm to approximately 2 mm above the surface of the conveyed roll paper 11. Wrinkles and slack in the roll paper 11 can therefore catch on the notches 52 more easily than when the surface of the roll paper 11 and the top discharge guide surface 51 are separated.

As shown in FIG. 5 and FIG. 6A, a recess 53 is formed on both sides of the top discharge guide 50, that is, on both sides of the discharge side end 55 perpendicularly to the direction of the discharge path. As shown in FIG. 9 and FIG. 10, the width of the top discharge guide 50 between the inside of one recess 53 and the inside of the other recess 53, that is, the width of the discharge side end where the recesses 53 are formed, is less than the width of the roll paper 11 in this embodiment of the invention. In addition, the recesses 53 may be formed from both sides of the discharge side end 55 extending along the discharge path to both sides of the top discharge guide surface 51.

Therefore, in an inkjet printer 1 according to this embodiment of the invention, as shown in FIG. 10, when the user pulls on the roll paper 11 so that the roll paper 11 twists, the twisted edge of the roll paper 11 (denoted by Y in FIG. 10) catches on the recess 53, and sideways movement of the roll paper 11 is thus limited.

When roll paper 11 discharged from the paper exit 9 is pulled by the user to the side or diagonally upward in the inkjet printer 1 according to this embodiment of the invention, sideways movement of the roll paper 11 can be limited by the notches 52 and recesses 53 formed in the top discharge guide 50, and paper jams and cutting problems caused by the roll paper 11 being wrinkled and pushed widthwise to one side can be prevented.

The inkjet printer 1 according to this embodiment of the invention may be connected to a computer and used to print image data received from the computer. The inkjet printer 1 according to this embodiment of the invention may also be provided with some of the functions of the computer, a CRT or other display device, an input device, a floppy disk drive, and a CD-ROM drive. For example, The inkjet printer 1 could be formed with an image processing unit that processes images, a display unit that displays information, and a recording medium reader for reading recording media on which image data captured by a digital camera, for example, is recorded.

An inkjet printer 1 that prints on roll paper 11 is described as a preferred embodiment of the invention above, but is not so limited and may be any type of recording device that can record on recording media. The invention can also be applied, for example, to monochrome inkjet printers, laser printers, thermal printers, and other types of printers; facsimile machines; and recording devices that magnetically record data on magnetic tape or other type of recording medium.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A recording device that pulls and records on a recording medium that is wound in a roll, comprising:
a discharge guide member that forms a discharge path for the recorded recording medium, wherein the discharge guide member has a discharge guide surface facing a surface of the recording medium, and
a notch unit disposed on a discharge-side end of the discharge guide surface.

2. The recording device described in claim 1, wherein:
the notch unit is a groove in the discharge guide surface extending from the discharge-side end along the discharge path.

3. The recording device described in claim 1, wherein:
the discharge-side end has a recess formed on both sides in a direction perpendicular to a direction of the discharge path.

4. The recording device described in claim 1, wherein:
a width of the discharge guide surface is less than the width of the recording medium.

5. The recording device described in claim 1, wherein:
a plurality of notch units are disposed on the discharge-side end in a direction perpendicular to a direction of the discharge path.

6. The recording device described in claim 1, wherein:
the discharge guide surface is connected at the discharge-side end to a support unit that supports the discharge guide surface from a paper exit side from which the recording medium is discharged.

7. The recording device described in claim 1, wherein:
the discharge guide unit is disposed so that the discharge guide surface substantially touches a surface of the recording medium from above.

8. The recording device described in claim 1, further comprising:
a discharge roller that discharges the recording medium between a printhead and the discharge guide unit.

9. The recording device described in claim 8, further comprising:
a cutter mechanism that cuts the recording medium between the discharge roller and the discharge guide unit.

10. The recording device of claim 8, wherein the discharge guide surface is positioned approximately 1 mm to approximately 2 mm above the discharge roller.

11. A recording device that records on a recording medium that is wound in a roll, comprising:
a discharge guide member that forms a discharge path for the recording medium; and
notches formed in the discharge guide member.

12. The recording device of claim 11, wherein the notches are formed on a discharge side end of the discharge guide member.
